(19) United States
(12) Patent Application Publication
(10) Pub. No.: US 2025/0100594 A1
(43) Pub. Date: Mar. 27, 2025

(54) A SHEAR-OFF DEVICE FOR TRAIN COUPLERS

(71) Applicant: RXD - RESEARCH EXCHANGE DEVELOPMENT AB, Krylbo (SE)

(72) Inventor: Roger DANIELSSON, Krylbo (SE)

(73) Assignee: RXD - RESEARCH EXCHANGE DEVELOPMENT AB, Krylbo (SE)

(21) Appl. No.: 18/834,067

(22) PCT Filed: Jan. 31, 2022
(86) PCT No.: PCT/SE2022/050098

§ 371 Date: Jul. 29, 2024

(51) Int. Cl. B61G 9/10; B61G 9/20

(52) U.S. Cl. CPC B61G 9/10; B61G 9/20

(57) ABSTRACT

A shear-off device for a train coupler comprising a safety ring having an inner periphery formed with a thread for threaded engagement, and further comprising a radially inwards depending shear flange, the shear flange reaching in radial direction from the inner periphery towards the center axis of the safety ring, the shear flange having a flange base adjoining the inner periphery and a flange point reaching radially inside of the inner periphery.

### TECHNICAL FIELD OF THE INVENTION

The present invention relates to a shear-off device for train couplers adapted for absorption of energy in case of an impact that causes retraction of the train coupler into the undercarriage of a rail vehicle.

### BACKGROUND AND PRIOR ART

Energy dissipation or energy absorption devices are frequently applied as shock dampers at coupling interfaces between interconnected railway cars and in front-end couplers of motorized cars and locomotives. It is a challenge to designers of shock dampers in train couplers to manage the shock wave that propagates through the train set in parts of a second, from the first to the last unit of the train, in case of collision.

Although numerous older solutions can be found in literature and practise, there is still room for improvements both with respect to energy absorption structures and management strategy for dissolving the energy that is released in collision.

The subject energy dissipation devices can be referred to the category of passive, non-regenerative shock dampers designed to consume the energy, rather than storing energy in metal springs, elastomeric bodies, or hydraulic and gas-hydraulic arrangements, etc.

In the subject category of energy dissipating devices, numerous examples in the prior art relies on energy consumption by radial deformation and expansion of an outer tube having an inner diameter, the expansion being induced by a plunger or mandrel of greater diameter which is forced through the tube by the dynamics of an impact. It is also known the alternative design, wherein the deformation tube is deformed radially inwards by a compressive force applied from an outer member that is run down the exterior of the deformation tube.

If to mention one prior art example of radially deforming shock dampers, reference can be made to EP3205551 A1. Said document is of interest also for disclosing a pivot bearing which can be sheared off from the car chassis to be retracted into a deformation tube which is arranged in the car chassis behind the pivot. A rear face of the pivot bearing is formed with an extended diameter that causes radial expansion of the deformation tube as the pivot bearing is sheared off and retracted into the deformation tube upon impact.

For an example of axially deforming shock absorbers, reference can be made to EP3059137 B1. This design for a front-end coupler comprises a package of honeycomb-structured deformation elements which are installed between a pivot bearing in a front end of the honeycomb structure and a shear-off member in a rear end of the honeycomb structure. A couple of guide bars, in front ends fixed to the car chassis via a support element and in rear ends carrying the shear-off member, extend in parallel through the honeycomb structures which are positively guided on the guide bars during compression in order to avoid warping. A housing which is attached to the car chassis, or forming an integer part thereof, takes no active part in guidance of the honeycomb structures during compression.

It is further known that a steel tube can be controlled to fold progressively and buckle in a uniform manner when subjected to a compressive force applied in axial direction of the tube.

However, the development of crash forces through a train set in collision does not follow a monotonic and static scheme. On the contrary, halting the train to a stop is a dynamic process which involves a series of accelerations and retardations as each successive unit in the train crashes into the previous one. The series of internal impacts accumulate into a successively increasing load being transferred to train units and dampers that are closest to the point of collision. In respect of stroke length and energy absorption, the foremost dampers are typically fully exhausted in a crash. On the other hand, practise has also shown that the potential stroke lengths in dampers at intermediate interfaces of the train were only partially used as the train had come to a halt.

In particular, the present invention relates to a shear-off device adapted for integration in train couplers or in energy dissipation assemblies. In this aspect, as will be clear from the specification below, the present invention teaches away from the shear-off bolts that are conventionally applied in train coupler mountings.

### SUMMARY OF THE INVENTION

It is an overall objective of the present invention to provide a shear-off device of alternative design for integration in train couplers or in energy dissipation assemblies.

One objective of the present invention is to provide a shear-off device of lightweight design for integration in train couplers or in energy dissipation assemblies.

Another objective of the present invention is to provide a shear-off device that requires few or less complicated machining operations during manufacture or assembly.

Still another objective of the present invention is to provide a shear-off device which permits reuse of components of energy dissipation devices that remain unaffected after absorption of impact energy, and which provides simplified exchange of exhausted deformation elements.

It is another objective of the present invention to provide a shear-off device which can be integrated in front-end train couplers, in intermediate train couplers or in side buffers as well.

One or several of these objectives will be satisfied by a shear-off device as defined in claim 1.

In the present invention, a shear-off device for a train coupler comprises a safety ring having an outer periphery and an inner periphery in concentric relation about a centre axis, wherein the inner periphery is formed with a thread for threaded engagement with a supporting structure that is receivable via an open forward end of the safety ring leading to the thread. An inwardly depending shear flange is integrally formed in an opposite rear end of the safety ring, the shear flange reaching in radial direction from the inner periphery towards the centre of the safety ring. The shear flange has a flange base adjoining the inner periphery and a flange point reaching radially inside of the inner periphery of the safety ring.

An advantage and technical effect provided by this solution is that a linear retraction of coupler components in shear-off can be ensured through the provision of an integrated shear-off component which is arranged in axial alignment with the coupler for a controlled fracture development in shear-off.

In one embodiment, a first indication of fracture is formed in the safety ring where the base of the shear flange adjoins the inner periphery. An advantage and technical effect provided by this embodiment is that the location of an opening fracture can be predetermined.

In one embodiment, a second indication of fracture is formed in the face of the rear end of the safety ring. An advantage and technical effect provided by this embodiment is that the propagation of a fracture through the shear flange can be additionally predetermined and controlled.

The first and/or second indication(s) of fracture can be formed as a continuous circular recess with a rounded or semi-circular sectional profile. An advantage provided by this embodiment is that the load applied in shear-off is distributed in the material and the breaking limit can be moved forward without adding material to the shear flange.

The shear flange may be given various sectional profiles depending on application. For example, the shear flange may have an equal and continuous transverse dimension and thickness from the flange base to the flange point. In other embodiments, the thickness of the shear flange may be reducing from the flange base towards the flange point. The shear flange may be given a trapezoidal sectional shape with a forward-facing side that is slanting towards the centre axis and in relation to the inner periphery of the safety ring.

In one embodiment, a forward-facing side of the shear flange is slanting at an angle in the range of about 110° to about 150° in relation to the inner periphery of the safety ring. A technical effect provided by this embodiment is that the shear flange will be subjected to circumferential tension and radial expansion in shear-off, which results in fragmentation of the shear flange into more pieces and a more even absorption of shearing forces.

With the objective of achieving a controlled fragmentation of the shear flange in shear-off, the shear flange may be divided into three or more sections which are separated by slots that extend in radial direction from the flange point towards the flange base.

In one embodiment, the shear flange comprises a number of individual tongues extending at a rearward slanting angle towards the centre axis of the safety ring, from a tongue base at the inner periphery to a tongue point protruding beyond the rear end of the safety ring.

In one embodiment, the tongue bases are connected to a conical surface that runs about the inner periphery of the safety ring, at a slanting angle facing forward and inwards towards the centre axis. In this embodiment, the tongue base may be connected to the conical surface via a thinned-out portion. The conical surface may be arranged to adjoin the inner periphery of the safety ring at an angle of about 110° to about 150° in relation to the inner periphery. A transition region between the conical surface and the inner periphery may be formed with a radius. Slots between adjacent tongues may likewise be formed with a radius at the tongue base.

In one embodiment, the shear-off device comprises a safety ring which is adapted for threaded engagement with the rear end of a cylindrical housing of an energy dissipation assembly, the housing in a forward end connectable in alignment with a passage through a bracket for a pivot bearing, and wherein a disc-shaped counterpressure means in the housing is pre-tensioned towards the safety ring such that a bevelled periphery of the counterpressure means bears against the forward facing side(s) of the shear flange, the shear flange sections or the tongues, respectively.

This embodiment is adapted for integration in front-end couplers as well as intermediate couplers between cars, wherein coupler components such as the pivot and pivot bearing are designed to be released to retract under the car chassis if subjected to an impact force above a magnitude that causes compression of energy absorption components and release of the shear-off device.

An advantage and technical effect provided by this embodiment is that the housing of the energy dissipation assembly can be preserved and intact after shear-off, since the shear-off device includes a replaceable component, namely the safety ring with the shear-off elements, which can be dismounted from the housing by means of the threaded engagement.

Alternatively, the safety ring may be adapted for threaded engagement with a separate mounting ring which by means of bolts can be bolted directly to the rear face of a bracket for the pivot bearing of a train coupler, in alignment with a passage through the bracket for the pivot bearing in case of shear-off, to which purpose bolt passages may be formed in the outer periphery of the safety ring.

An advantage and technical effect provided by the shear-off device in each alternative mounting method is that shear-off motion and retraction of coupler components is not affected by lateral forces, as might be the case in connection with sets of shear-off bolts engaging the coupler or pivot bearing from opposite sides thereof. This technical effect, in words of a linear retraction of coupler components in shear-off, can be ensured through the provision of an integrated shear-off component/shear flange arranged in axial alignment with the coupler.

In a second aspect of the invention, a shear-off assembly for a train coupler comprises a combination of the safety ring and a disc-shaped counterpressure means formed with a bevelled periphery that is angularly adapted to be pretensioned in close contact between the bevel of the counterpressure means and opposing angled faces formed in the shear flange, on flange sections, or on tongues respectively, of the safety ring.

Further details, advantages and technical effects of the invention will appear from the detailed description provided below with references made to accompanying, schematic drawings.

### SHORT DESCRIPTION OF THE DRAWINGS

In the drawings,

FIG. 1 is a sectional view through the centre axis of a shear-off device of a first embodiment,

FIG. 2 is a sectional view through the centre axis of a shear-off device of a second embodiment,

FIG. 3 is a cut out portion showing a third embodiment of the shear-off device in sectional view,

FIG. 4 is a cut out portion showing a fourth embodiment of the shear-off device in sectional view,

FIG. 5 is a cut out portion showing a fifth embodiment of the shear-off device in sectional view,

FIG. 6 illustrates implementation of the shear-off device in an energy dissipation assembly for a train coupler,

FIG. 7 illustrates implementation of the shear-off device and energy dissipation assembly in a front-end coupler,

FIG. 8 illustrates implementation of the shear-off device and energy dissipation assembly in an intermediate train coupler,

FIG. 9 illustrates implementation of the shear-off device in a bearing bracket for a pivot bearing of a train coupler,

FIG. 10 is another cut out portion showing the fifth embodiment of the shear-off device in sectional view,

FIG. 11 is a force-stroke diagram illustrating operation of the shear-off device in cooperation with the energy dissipation assembly shown in FIG. 6, and

FIG. 12 is a sectional view through the centre axis of a shear-off device and counterpressure means assembly according to the invention.

### DETAILED DESCRIPTION OF PREFERRED EMBODIMENTS

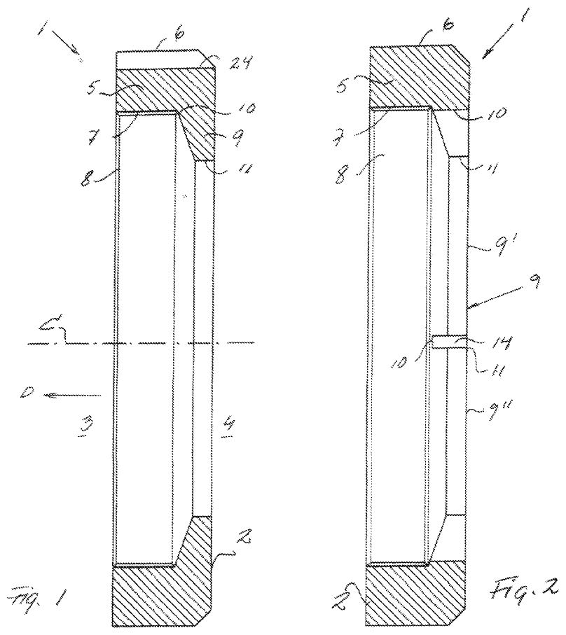

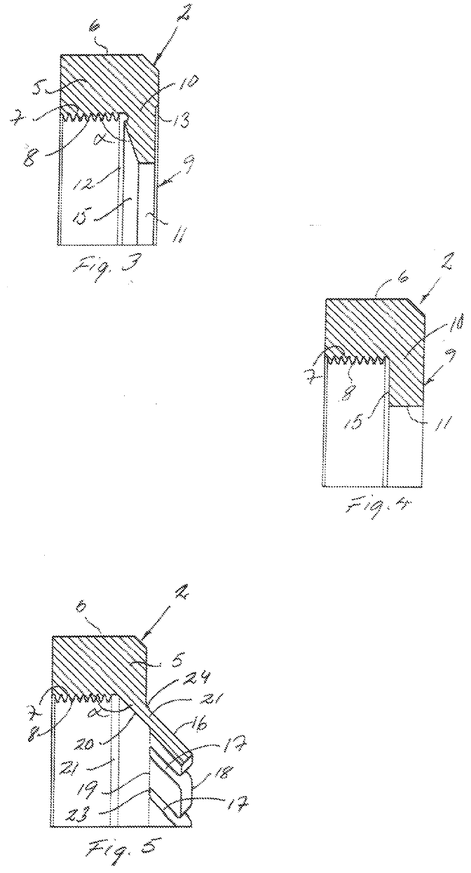

In the drawings, FIGS. 1 and 2 show a shear-off device 1 in sectional view through the centre axis C of a rotationally symmetric component forming a safety ring 2. The safety ring 2 has an axial extension from a first end 3 to a second end 4. With reference to the orientation of the safety ring in use, the first end forms a front face 3 and the second end forms a rear face 4 as seen in the draft direction D of a railcar or locomotive. The safety ring 2 comprises a circular web portion 5 which is defined by an outer periphery 6 and an inner periphery 7. The inner periphery 7 carries a thread 8 (see also FIGS. 3, 4, 5) adapted for threaded engagement with a support structure that is insertable via the open forward end of the safety ring 2.

The rear end 4 of the safety ring 2 is partially blocked by a shear flange 9. The shear flange 9 reaches in radial direction from the inner periphery 7 towards the centre axis C, the shear flange having a flange base 10 adjoining the inner periphery 7 and a flange point 11 reaching radially inside of the inner periphery.

In order to positively determine and locate a crack formation and fracture propagation through the shear flange 9 in shear-off, an indication of fracture may be formed in the safety ring 2 in the region where the base 10 of the shear flange adjoins the inner periphery 7.

With reference to FIG. 3, an indication of fracture may be applied in the form of a continuous recess 12 running around the inner periphery 7. If appropriate, the indication of fracture may be formed with a rounded recess bottom, which can also be of semi-circular or part-circular shape.

An additional indication of fracture 13 may be formed in the rear face 4 of the safety ring 2. The second indication of fracture 13 may be positioned radially between the inner and outer peripheries of the safety ring 2.

FIG. 2 shows an alternative embodiment of the safety ring 2. The embodiment of FIG. 2 differs from the embodiment of FIG. 1 in that the shear flange 9 is divided into sections 9′, 9″. The flange sections 9′, 9″are separated by slots 14 that extend in radial direction from the flange point 11 towards the flange base 10. The shear flange 9 may advantageously be partitioned into three or more sections.

FIGS. 3, 4 and 5 are examples of alternative sectional profiles that can be applied to the shear flange 9. Thus, the shear flange 9 of FIG. 3 comprises a slanting forward-facing side 15 in a flange that has a wall thickness which is reducing from the flange base 10 towards the flange point 11. The forward-facing side 15 can be arranged at an inclination α in the order of about 110° to about 150°, e.g., with respect to the inner periphery 7.

The shear flange 9 of FIG. 4 has a continuous wall thickness throughout its extension from the flange base 10 to the flange point 11. In the embodiment of FIG. 4, the forward-facing side 15 is arranged at 90° angle with respect to the inner periphery 7. As an alternative embodiment (not shown), a shear flange of continuous wall thickness may be arranged to have a rearward pointing inclination, likewise presenting a slanting forward-facing side with respect to the inner periphery.

In both FIGS. 3 and 4 embodiments, the shear flange 9 may be divided into sections as illustrated in FIG. 2.

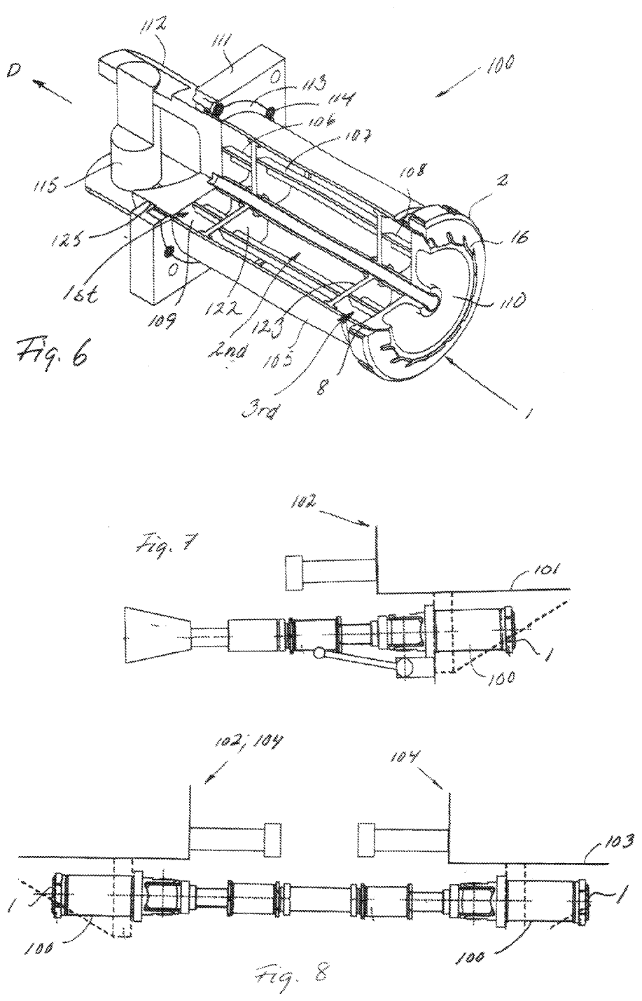

The embodiment of FIG. 5 is characterized by a shear flange 9 that is split into a number of tongues 16. The tongues 16 are distributed about an inner circumference in the rear end of the safety ring 2. Adjacent tongues 16 are separated by slots 17 that extend in radial direction from a tongue point 18 towards a tongue base 19. At the tongue bases, the tongues are attached to a flange base 20 that is arranged with an inclination α relative to the inner periphery 7. The angle α can be in the order of about 110° to about 150° with respect to the inner periphery 7. From the flange base, the tongues extend rearward at a slanting angle, protruding beyond the rear face of the safety ring. At a transition region 21, leading from the tongue 16 to the flange base 20, the tongue or flange base may be formed with reduced wall thickness providing a bending indication. In order to improve resistance towards fracture, radii can be applied at 22, 23 and 24 to improve breaking strength at critical positions in the safety ring.

By proper choice of steel grade, the tongues 16 can be designed this way to provide a yield limit up to which the tongues deform rather than break, before shear-off.

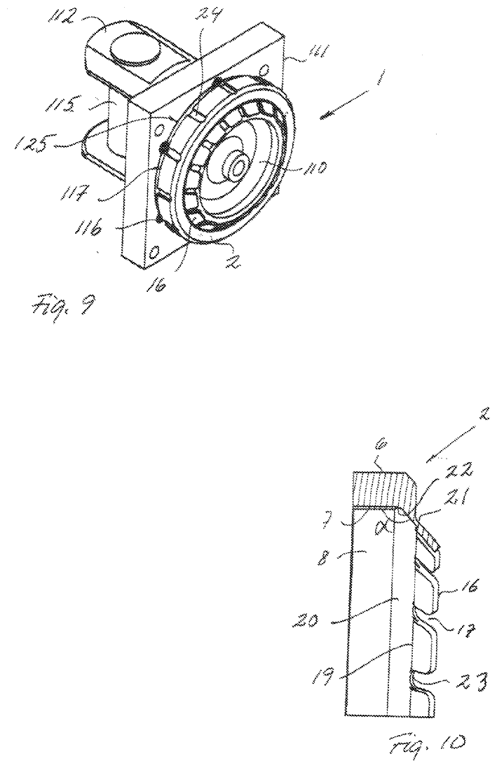

FIG. 6 illustrates implementation of the shear-off device 1 with in an energy dissipation assembly 100. The energy dissipation assembly 100 is adapted for mounting in the underframe 101 of a motor car or locomotive 102 (FIG. 7) or in the underframe 103 of a trailing car 104 (FIG. 8). The energy dissipation assembly 100 comprises a housing 105 wherein axially compressible steel elements 106, 107 or 108 are installed and pre-tensioned axially between a compression means 109 and a counterpressure means 110. A forward end of the housing 6 is arranged for coupling to a structural component of the underframe, i.e., arranged for coupling to a bracket 111 for a pivot bearing 112. To this purpose, engaging threads are formed on the outer periphery of the housing for threaded engagement with threads formed on an inner periphery of a mounting ring 113. The mounting ring 113 is bolted to the bearing bracket 111 by means of bolts 114.

The pivot bearing is operatively connected to the bearing bracket for transfer of traction forces to a trailed unit in the draft direction D. Compressive forces in the opposite or buff direction is transferred via the deforming elements 106-108 to the shear-off device 1 which is coupled to the opposite rear end of the housing 105 by threaded engagement between the threads 8 on the inner periphery of the safety ring 2 and threads formed on the outer periphery of the housing.

In case of an impact of sufficient magnitude being applied to the pivot bearing in the buff direction, the pivot bearing 112 and pivot pin 115 will relocate from the bearing bracket 111, passing via a through passage 125 in the bearing bracket and slide through the interior of the housing 105, axially compressing the elements 106-108 and ultimately forcing the counterpressure means 110 through the safety ring 2, breaking off the shear flange, the flange sections or tongues from the web portion 5 of the safety ring.

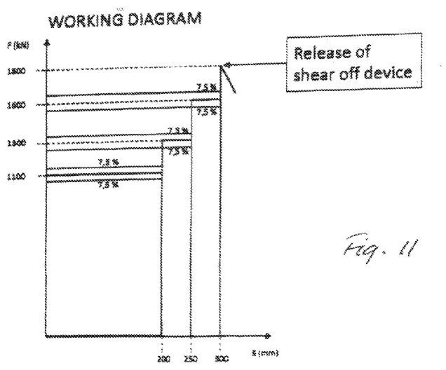

An alternative implementation of the shear-off device 1 is shown in FIG. 9. In the embodiment of FIG. 9, the shear-off device 1 is mounted in alignment with a passage 125 through the bracket for the pivot bearing 112 by being coupled to the rear face of the bearing bracket 111 by means of bolts 116 and a mounting ring 117, onto which the safety ring 2 is secured in threaded engagement. For this purpose, bolt passages 24 may be formed in the outer periphery 6 of the safety ring 2.

In both implementations, see FIGS. 6, 9 and 12, a counterpressure means 110 forms an operative component of a shear-off assembly comprising the shear-off device 1 and the counterpressure means 110. The counterpressure means 110 is disc-shaped and may have a rotationally-symmetric geometry, defined by a front face 118, a rear face 119 and an outer periphery 120. The front face 118 may be flat or shaped to accommodate the impact from energy absorbing elements or from coupling components in case of an impact. The rear face carries a rearward facing bevel 121 which is slanting at an angle that is adapted to the slanting angle α in the forwards facing side of the shear flange 9. In the shear-off assembly 1,110, the shear-off device 1 and the counterpressure means 110 are mounted in close contact between the bevel 121 and the opposing, forward slanting faces 15 or 20 of the safety ring, respectively.

FIG. 10 shows another cut-out portion of the safety ring 2. Via a thinned-out portion 21, the yieldable tongues 16 adjoin an inwardly bevelled and conical face 20 that runs circumferentially about the inner periphery of the safety ring 2. The conical face 20 adjoins the threaded cylindrical inner periphery 7 at an angle of about 110° to about 150°, preferably of about 135°. The transition from the conical face 20 to the inner periphery 7 can be made with a radius at 22 in order to avoid fracture indications at the transition region. For a similar reason, gaps 17 between adjacent tongues 16 may be formed with a radius 23 at the tongue base and connection to the conical face 20.

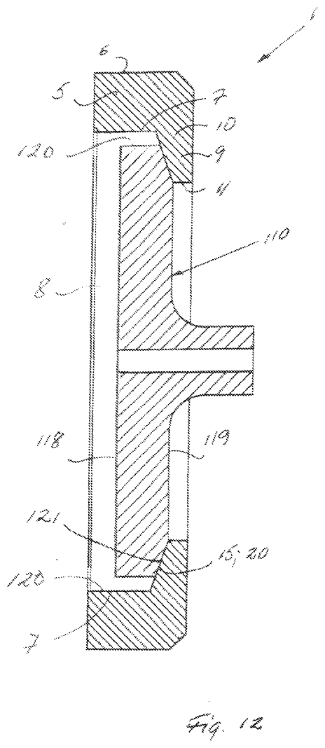

In the assembly of shear-off device 1 and the energy dissipation assembly 100, the housing 105 accommodates a pair of partition discs 122, 123, which divide the housing in three separate deformation zones, in FIG. 11 named 1^{st}, 2^{nd} and 3^{rd} deformation zones, each of which contains at least one compressible element 106, 107 and 108. Thus, the first, second and third deformation zones may be equipped and “charged” with compressible elements of different compression strengths and deformation resistance. FIG. 11 illustrates the damping characteristics of a three-zoned energy dissipating assembly 100, wherein the first deformation zone 1^{st} is equipped to yield under an impact force of 1100 kN, a second zone 2^{nd} is yielding under a force of 1300 kN, and a third zone 3^{rd} resists up to 1600 kN before yielding. Finally, the shear-off device 1 releases at an impact force of 1800 kN. In the example illustrated in FIG. 11, the total length of compression is 300 mm before shear-off. It should be realized, though, that FIG. 11 illustrates a non-limiting example.

1. A shear-off device for a train coupler, the shear-off device comprising a safety ring in the form of a rotationally symmetric component having a cylindrical web portion defined by an outer periphery and an inner periphery in concentric relation about a center axis, wherein the inner periphery is formed with a thread in an open first or forward end of the safety ring, wherein in an opposite second or rear end of the safety ring a shear flange is formed, the shear flange reaching in radial direction from the inner periphery of the safety ring towards the center axis, the shear flange having a flange base adjoining the inner periphery, and a flange end reaching radially inside of the inner periphery, wherein the shear flange is divided into sections separated by slots that extend in radial direction from the flange end towards the flange base.

2. The shear-off device of claim 1, wherein the shear flange comprises a number of individual tongues separated by slots and extending rearward at a slanting angle towards the center axis of the safety ring, from a tongue base at the inner periphery to a tongue point protruding in the rearward direction beyond the rear end of the safety ring.

3. The shear-off device of claim 2, wherein tongue bases are connected to a flange base facing forward and inwards at a slanting angle towards the center axis of the ring.

4. The shear-off device of claim 3, wherein the tongue bases connect to the flange base via a transition region of reduced wall thickness.

5. The shear-off device of claim 3, wherein the flange base adjoins the inner periphery at an angle of 110° to 150° in relation to the inner periphery of the safety ring.

6. The shear-off device of claim 4, wherein a transition region between the flange base and the inner periphery is formed with a radius.

7. The shear-off device of claim 2, wherein the slots between adjacent tongues are formed with a radius at the tongue base.

8. The shear-off device of claim 1, wherein an indication of fracture is formed in the safety ring where the base of the shear flange adjoins the inner periphery.

9. The shear-off device of claim 1, wherein an indication of fracture is formed in the rear end of the safety ring.

10. The shear-off device of claim 8, wherein the indication of fracture is a continuous circular recess with a rounded sectional profile.

11. The shear-off device of claim 1, wherein the shear flange is of equal thickness from the flange base to the flange end.

12. The shear-off device of claim 1, wherein the thickness of the shear flange is reducing from the flange base towards the flange end.

13. The shear-off device of claim 1, wherein the safety ring is adapted for threaded engagement with a rear end of a cylindrical housing of an energy dissipation assembly, the housing in a forward end connectable to a rear face of a bracket for a pivot bearing, in alignment with a passage through the bracket for retraction of the pivot bearing in case of collision, and wherein a disc-shaped counterpressure means in the housing is pre-tensioned towards the ring such that a bevelled periphery of the counterpressure means bears against forward slanting faces of the shear flange sections.

14. The shear-off device of claim 1, wherein the safety ring is adapted for threaded engagement with a mounting ring which by means of bolts can be bolted directly to the rear face of a bracket for a pivot bearing, in alignment with a passage through the bracket for retraction of the pivot bearing in case of shear-off, to which purpose bolt passages are formed in the outer periphery of the safety ring.

15. A shear-off assembly for a train coupler, comprising a shear-off device, the shear-off device comprising a safety ring in the form of a rotationally symmetric component having a cylindrical web portion defined by an outer periphery and an inner periphery in concentric relation about a center axis, wherein the inner periphery is formed with a thread in an open first or forward end of the safety ring, wherein in an opposite second or rear end of the safety ring a shear flange is formed, the shear flange reaching in radial direction from the inner periphery of the safety ring towards the center axis, the shear flange having a flange base adjoining the inner periphery, and a flange end reaching radially inside of the inner periphery, wherein the shear flange is divided into sections separated by slots that extend in radial direction from the flange end towards the flange base, wherein a disc-shaped counterpressure means is formed with a bevelled periphery that is adapted angularly to be pretensioned in close contact between the bevel of the counterpressure means and forward-facing sides of the shear flange sections.
